(19) United States
(12) Patent Application Publication
(10) Pub. No.: US 2006/0118682 A1
(43) Pub. Date: Jun. 8, 2006

(54) Furniture leg assembly

(75) Inventors: Warren Hayden Asquith, Mount Annan (AU); Dean Andrew Kuch, Cronulla (AU)

Correspondence Address: LADAS & PARRY, 26 WEST 61ST STREET, NEW YORK, NY, 10023, US

(73) Assignee: THINKING ERGONOMIX PTY LIMITED.

(21) Appl. No.: 11/285,792

(22) Filed: Nov. 22, 2005

(30) Foreign Application Priority Data
Nov. 25, 2004 (AU) 2004906747

(51) Int. Cl. F16M 11/26

(52) U.S. Cl. 248/188.5

(57) ABSTRACT

A height adjustable leg 10 for an office desk. The leg 10 includes an upper plate 11 to be attached to a workbench top, and a base to rest on a floor surface. The plate 11 and base 12 are coupled by means of a telescopic assembly including an outer tubular member 14 that telescopically receives an inner tubular member 15. Providing for sliding telescopic movement of the member 15 within the member 14 is a first bearing 23 fixed to the upper extremity 24 of the member 14, and a second bearing 25 fixed to the lower extremity of the member 15.

### TECHNICAL FIELD

The present invention relates to legs for furniture assemblies and more particularly but not exclusively to legs for work benches such as desks that enable height adjustment of the work surface.

### BACKGROUND OF THE INVENTION

Typically desks employed in offices have a top generally planar work surface that is supported by two height adjustable legs. Adjustment of the legs can be performed manually or alternatively by operation of an electric motor. Examples are described in U.S. Pat. Nos. 5,337,668 and 4,850,563.

These previously known height adjustable legs include a pair of telescopically associated tubular members that telescopically extend and retract to change the height of the working surface of the desk. One of the tubular members slidably engages within the other. Typically a bearing will facilitate this sliding movement.

A disadvantage of the above discussed construction is that the telescopically associated members frequently do not securely engage with a result that the work surface can move during use, that is, it is not stable. This movement is a result of the diameter tolerances in respect of the internal diameter of the outer tube and the outer diameter of the inner tube.

### OBJECT OF THE INVENTION

It is the object of the present invention to overcome or substantially ameliorate the above least one of the above disadvantage.

### SUMMARY OF THE INVENTION

There is disclosed herein a furniture leg including:

a first longitudinal member to be oriented so as to be longitudinally upwardly extending;

a second longitudinal member to be oriented so as to be longitudinally upwardly extending and telescopically received within the first member;

an upper bearing and a lower bearing extending between the first and second members to provide for sliding relative telescopic movement therebetween, and wherein at least one of the bearings is attached to one of the longitudinal members and has projections extending radially to slidably engage the other longitudinal member.

Preferably, said projections are longitudinally extending ridges.

Preferably, each bearing is attached to a respective one of the longitudinal members and each has radially extending ridges to engage the other longitudinal member.

Preferably, said first member is a lower member, and said second member is an upper member, with said first member extending upwardly to an upper extremity, and said second member extending downwardly into said first member so as to terminate with a lower extremity located within the first member and extending upwardly therefrom so as to extend beyond said upper extremity.

Preferably, a first one of said bearings is attached to said first member adjacent the upward extremity thereof and the other bearing is attached to said second member adjacent the lower extremity thereof

There is further disclosed herein a method of assembling a furniture leg said method including the steps of:

providing a first longitudinally extending hollow member having an extremity;

providing a second longitudinally extending member to be telescopically associated with the first member and having an extremity; and

attaching a first bearing to one of the extremities and then inserting one of the members into the other member so as to shear portion of the bearing from the bearing so that the bearing slidably engages the other member.

Preferably, this method includes attaching a second bearing to the other member and shearing a portion from the second bearing so that the second bearing slidably engages the said one member.

Preferably, the above method includes moving said second bearing passed said second member so as to shear portions from said second bearing prior to moving said second bearing into engagement with said first member.

Preferably, said portions are longitudinally extending ridges.

### BRIEF DESCRIPTION OF THE DRAWINGS

A preferred form of the present invention will now be described by way of example with reference to the accompanying drawings wherein;

FIG. 1 is a schematic isometric view of a desk leg;

FIG. 2 is a schematic sectioned side elevation of the desk leg of FIG. 1;

FIG. 3 is a schematic plan view of a first bearing employed in the desk leg of FIGS. 1 and 2;

FIG. 4 is a schematic sectioned side elevation of the bearing of FIG. 3 sectioned along the line 4-4;

FIG. 5 is a schematic plan view of a second bearing element employed in the leg of FIGS. 1 and 2;

FIG. 6 is a schematic sectioned side elevation of the bearing of FIG. 5 sectioned along the line 6-6;

FIG. 7 is a schematic bottom plan view of the bearing of FIG. 5;

FIG. 8 is a schematic sectioned side elevation of portion of the leg of FIGS. 1 and 2;

FIG. 9 is a schematic sectioned side elevation of portion of the leg of FIG. 8; and

FIG. 10 is a schematic sectioned side elevation of portion of the leg of FIG. 8.

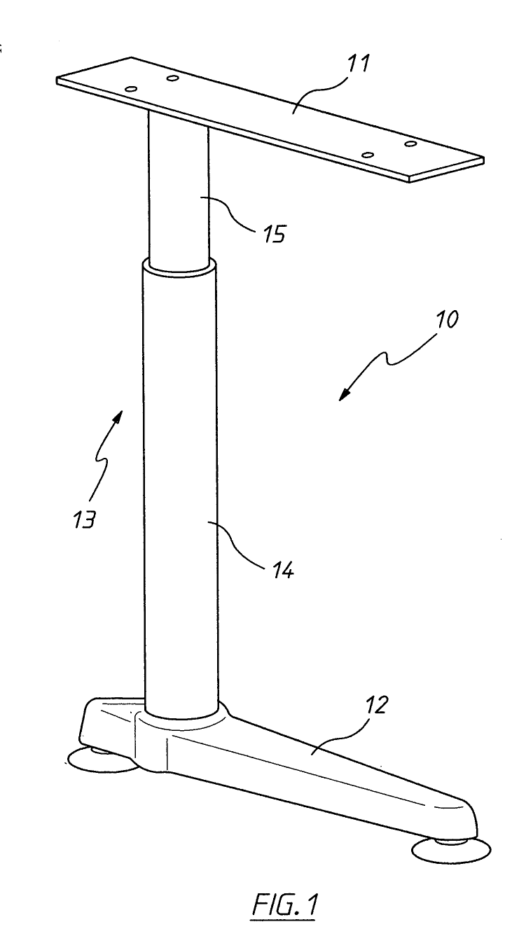

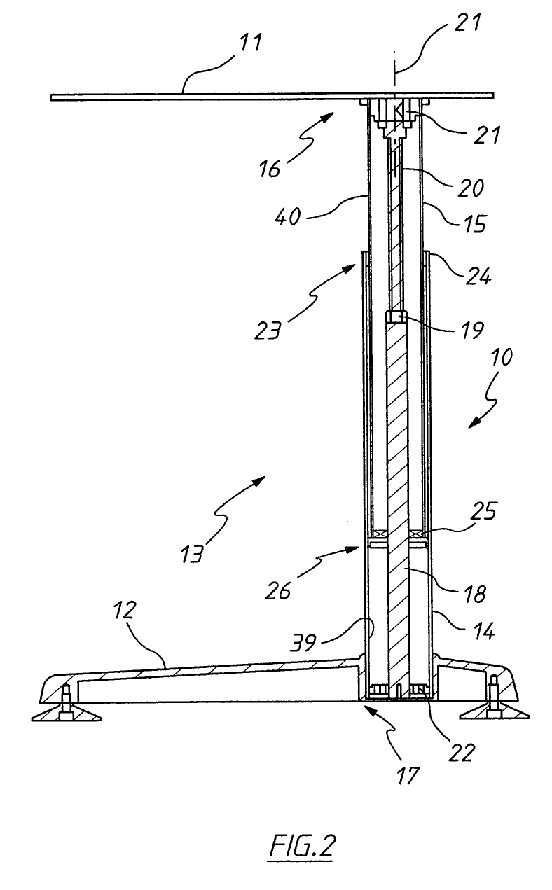

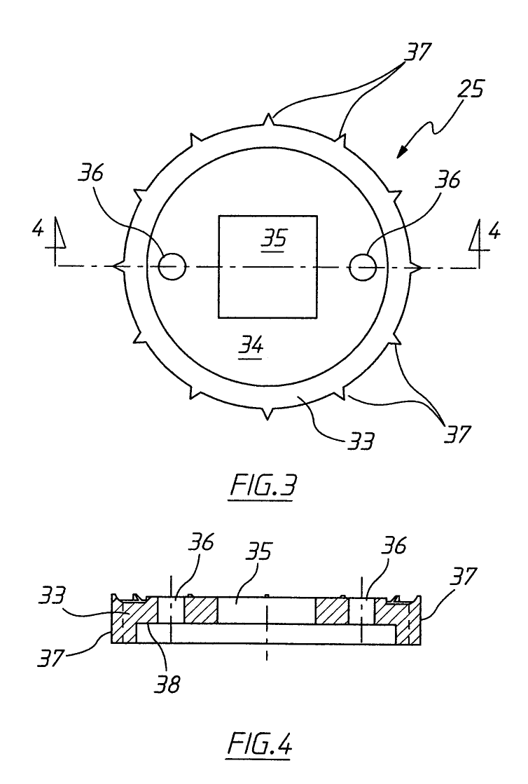

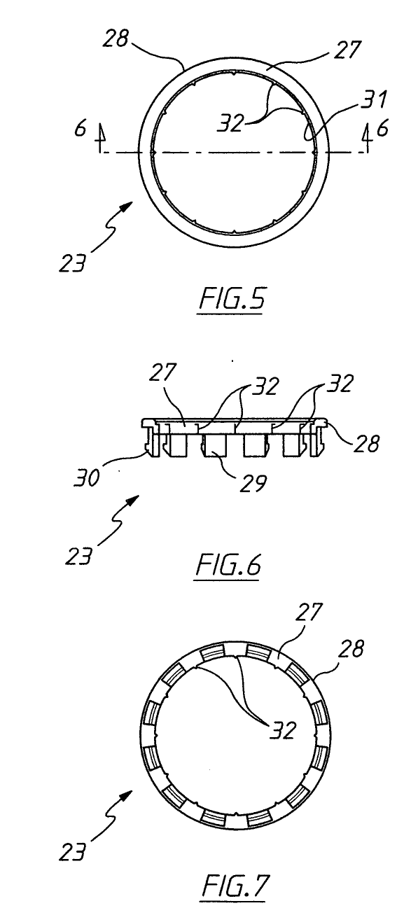

### DETAILED DESCRIPTION OF THE PREFERRED EMBODIMENT

In the accompanying drawings there is schematically depicted a height adjustable leg 10 for an office desk. The leg 10 includes an upper plate 11 which is to be attached to a work bench top, the work bench top providing a work surface. The work bench may be a desk. The leg 10 further includes a base 12 that rests on a floor surface. The plate 11 and base 12 are coupled by means of a telescopic assembly 13 including an outer tubular member 14 that telescopically receives an inner tubular member 15. The upper extremity 16 of the inner tubular member 15 is attached to the plate 11 while the lower extremity 17 of the outer tubular member 14 is attached to the base 12.

Fixed to the lower extremity 17 is a hollow post 18 having at its upper extremity a nut 19. The nut 19 is therefore fixed with respect to the base 12. Threadably engaged with the nut 19 is a threaded shaft 20 that is rotated about its longitudinal axis 21 to cause vertical movement of the threaded shaft 20. The upper end of the threaded shaft 20 is drivingly engaged with a gear box 21 to which a drive shaft would extend to cause operation thereof to rotate the shaft 20. An electric motor would be drivingly associated with the drive shaft extended to gear box 21, with the electric motor being operated to cause vertical movement of the threaded shaft 20. Accordingly by operation of the electric motor, the plate 11 is moved vertically to thereby adjust the height of the work bench.

The lower extremity 17 is fixed to the lower end of the post 18 by means of a collar 22.

Providing for sliding telescopic movement of the member 15 within the member 14, is a first bearing 23 fixed to the upper extremity 24 of the member 14, and a second bearing 25 fixed to the lower extremity of the member 15.

The bearing 23 is moulded from plastics material and includes a ring 27 having a radially outer surface 28 that extends angularly about the axis 21 while also extending longitudinally relative thereto. Depending from the ring 27 are resilient fingers 29 each with a radially outward extending barb 30. The ring 27 also has a radially inner surface 31 from which there extends radially inwardly a plurality of longitudinal ridges 32. The ridges 32 are equally spaced angularly about the longitudinal axis 21.

The bearing 25 is moulded from plastics material and includes a ring 33 and a central flange 34 having a square central aperture 35. The post 18 (that is of a square transverse cross-section) extends through the aperture 35. The flange 34 further has two spaced circular passages 36.

Extending radially outward from the ring 33 are longitudinally extending ridges 37, the ridges 37 being spaced angularly about the longitudinal axis 21 at regular angular displacements. The ring 36 is further provided with a circular step 38.

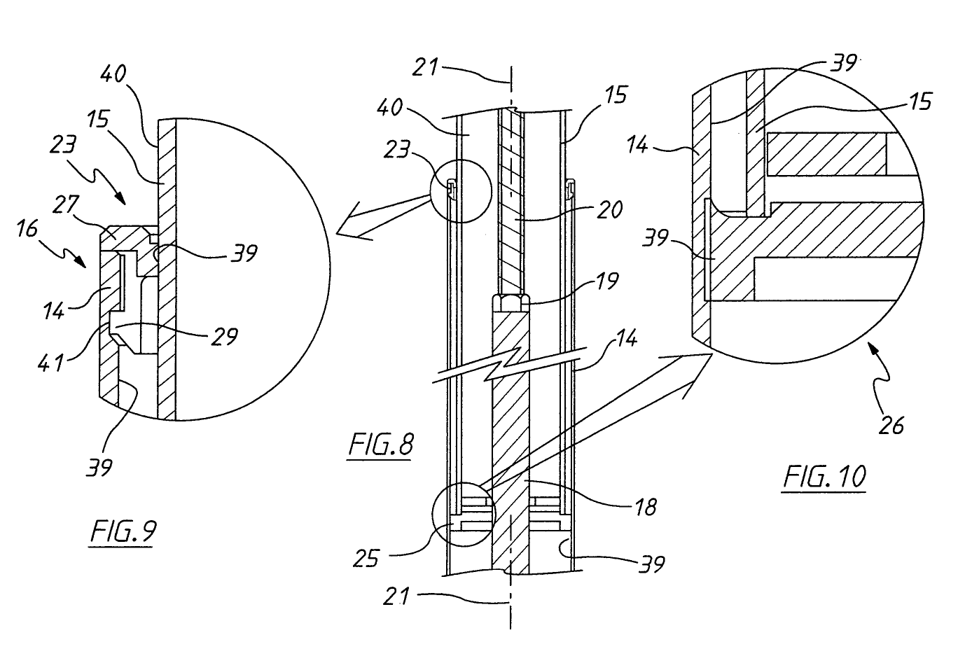

In assembling the above described telescopic assembly 13, the bearing 25 is attached to the lower extremity of the member 15 and inserted in the member 14. As the ridges 37 engage the upper edge of the upper extremity 24, the ridges 37 are partly sheared off so as to slidably fit within the member 14 and more particularly slidably engage the cylindrical inner surface 39 of the member 14. Accordingly, the bearing 23 adapts to the internal diameter tolerance of the member 14. Thereafter the bearing 23 is placed over the upper edge of the upper extremity 16 so that the ridges 23 engage the member 15. Pressure is applied to the bearing 23 so that portion of each of the ridges 23 is sheared off so that the bearing 23 slidably fits the outer cylindrical surface 40 of the member 15. Thereafter the bearing 23 is moved down to engage the upper extremity 24. As best seen in FIG. 9, the upper extremity 16 of the member 15 is provided with an internal annular recess 41 that is engaged by the barbs 29 so that the bearing 23 is secured in position fixed to the member 14.

As best seen in FIG. 9, the ridges 32 have portion of extremities sheared off so as to slidably fit the cylindrical surface 40.

As best seen in FIG. 10, the bearing 26 is fixed to the lower extremity of the member 14, and has the ridges 37 partly sheared off so as to slidably engage the cylindrical internal surface 39.

By having the bearing securely engaging between the members 14 and 15, the work bench is inhibited from moving as relative movement believes the members is at least substantially prevented about from the telescopic movement.

1. A furniture leg including:
a first longitudinal member to be oriented so as to be longitudinally upwardly extending;
a second longitudinal member to be oriented so as to be longitudinally upwardly extending and telescopically received within the first member;
an upper bearing and a lower bearing extending between the first and second members to provide for sliding relative telescopic movement therebetween, and wherein at least one of the bearings is attached to one of the longitudinal members and has projections extending radially to slidably engage the other longitudinal member.

2. The furniture leg of claim 1, wherein said projections are longitudinally extending ridges.

3. The furniture leg of claim 1, wherein each bearing is attached to a respective one of the longitudinal members and each has radially extending ridges to engage the other longitudinal member.

4. The furniture leg of claim 1, wherein said first member is a lower member, and said second member is an upper member, with said first member extending upwardly to an upper extremity, and said second member extending downwardly into said first member so as to terminate with a lower extremity located within the first member and extending upwardly therefrom so as to extend beyond said upper extremity.

5. The furniture leg of claim 4, wherein a first one of said bearings is attached to said first member adjacent the upward extremity thereof and the other bearing is attached to said second member adjacent the lower extremity thereof.

6. A method of assembling a furniture leg said method including the steps of providing a first longitudinally extending hollow member having an extremity;
providing a second longitudinally extending member to be telescopically associated with the first member and having an extremity; and
attaching a first bearing to one of the extremities and then inserting one of the members into the other member so as to shear portion of the bearing from the bearing so that the bearing slidably engages the other member.

7. The method of claim 6, further including attaching a second bearing to the other member and shearing a portion from the second bearing so that the second bearing slidably engages the said one member.

8. The method of claim 7, further including moving said second bearing passed said second member so as to shear portions from said second bearing prior to moving said second bearing into engagement with said first member.

9. The method of claim 8, wherein said portions are longitudinally extending ridges.

10. The furniture leg of claim 2, wherein each bearing is attached to a respective one of the longitudinal members and each has radially extending ridges to engage the other longitudinal member.

11. The furniture leg of claim 2, wherein said first member is a lower member, and said second member is an upper member, with said first member extending upwardly to an upper extremity, and said second member extending downwardly into said first member so as to terminate with a lower extremity located within the first member and extending upwardly therefrom so as to extend beyond said upper extremity.

12. The furniture leg of claim 3, wherein said first member is a lower member, and said second member is an upper member, with said first member extending upwardly to an upper extremity, and said second member extending downwardly into said first member so as to terminate with a lower extremity located within the first member and extending upwardly therefrom so as to extend beyond said upper extremity.

13. The furniture leg of claim 10, wherein each bearing is attached to a respective one of the longitudinal members and each has radially extending ridges to engage the other longitudinal member.
